(19) United States
(12) Patent Application Publication
(10) Pub. No.: US 2021/0213771 A1
(43) Pub. Date: Jul. 15, 2021

(54) SECURITY ELEMENT

(71) Applicant: GIESECKE+DEVRIENT CURRENCY TECHNOLOGY GMBH, Munchen (DE)

(72) Inventors: Wolfgang DECKENBACH, Schechen (DE); Thomas GIERING, Kirchseeon (DE); Stephan STEINLEIN, Munchen (DE); Johann KECHT, Munchen (DE); Thomas HAPP, Munchen (DE)

(21) Appl. No.: 17/273,586

(22) PCT Filed: Sep. 6, 2019
(86) PCT No.: PCT/EP2019/025296

§ 371 Date: Mar. 4, 2021

(30) Foreign Application Priority Data
Sep. 7, 2018 (DE) 10 2018 007 096.5

(51) Int. Cl. B42D 25/328; B42D 25/364; B42D 25/373; B42D 25/382; G07D 7/1205; G07D 7/202; G07D 7/00

(52) U.S. Cl. CPC B42D 25/328; B42D 25/364; B42D 25/373; G07D 7/0032; G07D 7/1205; G07D 7/205; B42D 25/382

(57) ABSTRACT

A security transfer element includes a security element layer composite with a functional layer arranged to develop an optically variable effect for a viewer. On the opposite side of the functional layer with respect to the viewer, the security element layer composite has at least one luminescent substance. The luminescent substance has a primary emission wavelength and can be excited by an excitation radiation. The functional layer is configured to be opaque to the emission radiation of the luminescent substance. The security transfer element comprises a carrier film, and the security element layer composite is arranged on the carrier film in a detachable manner. The security element layer composite comprises a functional layer and an adhesive layer. The functional layer has an embossing lacquer with an embossed structure. The embossing lacquer is coated with a metallization. The adhesive layer comprises several luminescent substances.

The present invention relates to a security transfer element, a value document with a security element layer composite, a method for checking a value document, a checking unit, a value document processing apparatus and a system composed of a checking unit and/or value document processing apparatus and security transfer element and/or value document.

Value documents are understood to be sheet-shaped objects that represent for example a monetary value or an authorization and hence should not be producible arbitrarily by unauthorized persons. Hence, they have features that are not easy to manufacture, in particular not easy to copy, whose presence is an indication of authenticity, i.e. manufacture by an authorized body, or integrity. These features are often referred to as security elements. Important examples of such value documents are chip cards, coupons, vouchers, checks and in particular bank notes, shares, tokens, identity cards, credit cards and passports as well as labels, seals, packaging or other objects for identification or value protection.

The security elements make possible checking the authenticity of the value document and additionally serve as protection against or for the identification of an unauthorized copy. The security elements can be made available both individually and in the form of transfer bands. The transfer bands have a multiplicity of security elements configured as security transfer elements. These security transfer elements comprise the security elements, which are usually constructed in multiple layers and are each referred to as a security element layer composite. The security elements are prepared for forming the security transfer element on a transfer layer, wherein the order of the layers of the respective security element layer composite is the reverse of the order in which it is to be present later on the object to be protected. When the security transfer element is transferred to the object to be protected, the transfer layer is usually removed, for example peeled off. On the side of the security transfer element opposite the transfer layer, the security element layer composite has an adhesive layer, for example a heat-sealing adhesive, which is activated when the security element layer composite is transferred (application) to the value document or, for example, melts and adhesively bonds the respective security element layer composites to the value document. For this purpose, the transfer band with the heat-sealing adhesive layer is placed on the value document and, for example, pressed on by means of a heatable transfer stamp or a transfer roller and transferred to the object in the contour shape of the heated transfer stamp. Transfer elements, transfer bands and the transfer of transfer elements to target substrates are described, for example, in EP 0 420 261 B1 and WO 2005/108108 A2. The security transfer elements can be stamped out of the transfer band in a manner corresponding to a shape and transferred with the aid of, for example, a transfer stamp. Instead of being shaped by the transfer stamp during the transfer process, individual security transfer elements can already be present on the transfer band in the desired contour shape.

The document EP 1 880 864 B1 discloses a security transfer element. The security transfer element has a carrier foil. An adhesive layer is arranged on both sides of the carrier foil, wherein at least one adhesive layer is structured so that the security transfer element conveys an optically variable impression to a viewer when the viewing angle changes. In addition, at least one of the adhesive layers comprises a luminescent feature substance. A check of the luminescence behavior of the security transfer element can be made use of for checking authenticity.

From EP 1 972 464 A1 a security transfer element with luminescent features of semiconductor materials is known.

The security transfer elements known from the prior art are suitable for employing their luminescence behavior to check authenticity. However, the check result of the luminescence behavior depends on the value document, for example on its imprint, substrate or soiling, on which the security transfer element is applied.

It is therefore an object of the invention to improve the disadvantages of the prior art. In particular, it is the object of the invention to make available a security element with which a secure check of the security element or the security element layer composite for authenticity and/or completeness is made possible and environmental influences are prevented.

The object is achieved by a security transfer element, a value document, a checking method, a checking unit, a value document processing apparatus and/or a system according to the independent claims. Particularly advantageous embodiments of the invention are the subject matter of the dependent claims.

A security transfer element according to the invention comprises a security element layer composite and a carrier film. The carrier film is detachably connected to the security element layer composite. The security element layer composite has a functional layer. The functional layer has an optically variable effect that unfolds for a viewer of the security element layer composite after it has been transferred to a value document. This means that when viewed in incident light onto an upper side of the functional layer, a variable optical impression arises for a viewer depending on the viewing or illumination angle, for example a changed color impression, a moving pattern or a changed depth effect. The security element layer composite further comprises an adhesive layer. The security element layer composite has an upper side which, after the security element layer composite has been transferred to a value document substrate, faces the viewer. The adhesive layer, on the other hand, is arranged on the side of the functional layer which lies opposite the upper side, namely on the lower side of the security element layer composite. Further, the security element layer composite has at least one luminescent substance. The luminescent substance is arranged in the adhesive layer and/or in a luminescent substance layer in the security element layer composite. The luminescent substance layer is arranged on the side of the functional layer opposite the upper side, preferably between the adhesive layer and the functional layer. The luminescent substance has a primary emission radiation in a wavelength range between 700 nm and 2100 nm. Further, the luminescent substance can be excited by an excitation radiation in a wavelength range between 400 nm and 2100 nm, preferably between 700 nm and 2100 nm. The functional layer is opaque with respect to the emission radiation of the luminescent substance.

Opaque means here that the transmittance amounts to at most 50%, preferably at most 30%, particularly preferably at most 10%.

The functional layer is accordingly configured such that it hinders the radiation emitted by the luminescent substance in a wavelength range from 700 nm to 2100 nm to such an extent that it does not pass through the functional layer or only up to a significant, small extent and is recognizable on the upper side of the security element layer composite. The functional layer can thus be configured to be absorbent or attenuating and/or preferably reflective for the emission range of the luminescent substance. If the functional layer is configured to be attenuating, then a degree of attenuation of at least 50%, preferably 70%, particularly preferably more than 90%, is provided. In the case of a reflective functional layer, the degree of reflection preferably amounts to more than 50%, particularly preferably more than 80%. The excitation of the luminescent substance preferably takes place from the lower side of the security element layer composite. After excitation, the at least one luminescent substance emits emission radiation. This runs through the security element layer composite up to the functional layer and preferably does not or hardly penetrate through the functional layer. The emission radiation of the luminescent substance is not or only hardly recognizable on the upper side of the security element layer composite, but the emission radiation can be recognized from the lower side of the security element layer composite, since here the emission radiation of the luminescent substance can penetrate to the outside.

The, preferably wavelength-selective, opacity of the functional layer can be made available by a partial layer of the functional layer. The luminescent substance is particularly preferably arranged in the security element layer composite in such a manner that it is arranged below the layer which makes available the opacity of the functional layer, i.e. the luminescent substance is covered by opaque regions of the functional layer.

The security element layer composite can preferably be detected over its entire areal region with the aid of the luminescent substance. If the luminescent substance is arranged over the entire area (in incident light) of the security element layer composite, its completeness can be checked. With the methods of the prior art, the region of a value document occupied by a security element layer composite is usually left out when checking, since a check is not or hardly possible due to the optical variability and/or metalized region. If the value document was forged, the security transfer element could only be partially removed. With the removal, the forger would also remove at least part of the luminescent substance from the value document. When checking the security element layer composite for completeness with the aid of, for example, evaluating the intensity distribution of the emission radiation of the luminescent substance on the checked area of the value document, it would be recognized that, of the authentic value document, only a partial region of the area of the security element layer composite of the value document remains supplied with the luminescent substance. The forged value document can also be recognized with the aid of an area evaluation with regard to the intensity values of the emission radiation of the luminescent substance. As a further advantage of the invention, the luminescent substance cannot or can hardly be detected from the upper side of the security element layer composite. Rather, in particular, detection from the lower side of the security element layer composite and thus from the value document substrate is possible. The security element layer composite would customarily not be recognized by forgers as being machine-readable or as luminescent, since detection typically takes place from the upper side, but not from the lower side.

In one embodiment, the layer of the security element layer composite is structured in such a manner that when the security element layer composite is detached from a value document substrate, only part of the luminescent substance is removed and another part remains on the value document substrate. This can result from the material properties of the material surrounding the luminescent substance, for example a luminescent substance layer or adhesive layer, and/or this material is present in a specific geometric shape in the security element layer composite.

If at least part of the luminescent substance remains on the value document substrate, the forgery can also be recognized by measuring on two sides for emission radiation of the luminescent substance in that the emission radiation suddenly would be detectable from above.

With the security transfer element according to the invention, it is possible not only to check the authenticity of the security element layer composite, but also the integrity of the security element layer composite can be checked.

The emission radiation of the luminescent substance can comprise electromagnetic radiation with several emission bands, i.e. over a wide range of wavelengths. The term primary emission radiation therefore only relates to a specific wavelength range in which the intensity maximum lies and is the largest coherent wavelength range in which the total intensity does not fall below 90% of the maximum.

The luminescent substance of the security element layer composite can be excited by an excitation radiation in a wavelength range between 400 nm and 2100 nm. The structure and the security specifications for this are simple and straightforward, so that a simple check of the security element layer composite is possible.

The carrier film can be, for example, a plastic foil of PP, PET, PA, PC, PVC, PTFE or POM. The carrier film can also comprise a metal foil, for example Al, Cu or stainless steel foils.

If the luminescent substance is arranged in a luminescent substance layer, it can be provided in one embodiment that the luminescent substance layer is configured as a plastic layer. In this manner, luminescent organic or organometallic dyes can be well dispersed and at the same time protected from chemical attacks.

In one embodiment, the luminescent substance is configured in such a manner that its ability to be excited to luminescence is in the visible spectral range, in particular preferably in the wavelength range between 400 nm and 700 nm. When applying the security element layer composite on a value document substrate which comprises paper, there occur higher scattering losses of the excitation radiation in the value document substrate and a higher susceptibility to interfering factors such as dirt, but the range of usable substances is expanded, for example pigments, dyes and complexes excitable with visible radiation. The losses can, however, be more than compensated in part by using the generally stronger excitation sources present for this spectral range.

In one embodiment, the luminescent substance is configured in such a manner that its excitability lies in the infrared range, in particular preferably in the wavelength range between 700 nm and 2100 nm. In a particularly preferred embodiment, both the excitability and the emission are in the infrared range. This minimizes the scattering losses that typically occur when the security element layer composite is applied to a value document substrate which comprises paper. Surprisingly, it was found that with an increasing wavelength range, the scattering of the excitation radiation in a value document substrate which comprises paper decreases. In addition, it was surprisingly found that occurring absorptions caused for example by soiling are often more permeable to electromagnetic radiation in the infrared range than in the visible range.

The security element layer composite is preferably configured such that the luminescent substance can preferably be acted upon by excitation radiation from the lower side of the security element layer composite. This means that the layers which are arranged opposite the upper side of the security element layer composite from the luminescent substance are permeable to the excitation radiation to the extent that the excitation radiation can excite the luminescence substance to luminescence.

In one embodiment it can be provided that the excitation of the luminescent substance can take place from the upper side of the security element layer composite. For this purpose, at least one layer and/or the material that is arranged on the side of the luminescent substance which is directed towards the upper side of the security element layer composite is configured such that the excitation radiation can advance from the upper side of the security element layer composite to the luminescent substance and excite it to luminescence. The at least one layer and/or the material can be configured such that it guides electromagnetic radiation, namely the excitation radiation, only in the direction of the luminescent substance, but does not guide electromagnetic radiation, namely the emission radiation, to the surface of the security element layer composite.

In one embodiment, it can also be provided that an excitation is possible from the upper side and lower side of the security element layer composite.

In one embodiment, the security element layer composite can be configured in such a manner that an excitation radiation is blocked from the upper side of the security element layer composite or from the lower side of the security element layer composite.

In one aspect of the invention, the primary emission radiation of the luminescent substance is in a wavelength range between 900 nm and 2100 nm. As a result, the luminescence of the security element layer composite cannot be perceived by the human eye, so that greater security is achieved. If the security transfer element is applied to a value document substrate, wherein the value document substrate preferably contains paper, the emission radiation experiences fewer scattering losses due to the dependence of the scatter coefficient of the value document substrate on the wavelength, so that the emission radiation of the luminescent substance can penetrate through the value document substrate with fewer losses.

In one aspect, the primary emission radiation of the luminescent substance lies in a wavelength range between 900 nm and 1300 nm. Detectors of a simple construction type are already available for the detection of emission radiation in this wavelength range, so that it is not necessary to employ complex detectors. A compromise is thus achieved between simple detectability and scattering losses. For example, luminescent substances with a wavelength range of the primary emission radiation between 900 nm and 1300 nm are inorganic pigments doped with the dopants neodymium or ytterbium or doped with specific transition metals and organometallic complexes with neodymium or ytterbium and/or organic dyes, such as cyanine dyes, thiopyrylium dyes such as IR-1061 and/or indolium dyes such as IR-1048. In one embodiment, a combination of neodymium and ytterbium can also be provided.

In a further aspect, the primary emission radiation of the luminescent substance lies in a wavelength range between 1300 nm and 1600 nm. In comparison to a wavelength range below 1300 nm, there are again reduced scattering losses in a paper substrate in the case of a value document substrate and the detectors can still be constructed relatively simply. However, in the case of cellulose-based substrates of the value document substrate, a broad absorption band can be present due to a superposition of different O—H stretching vibration, as a result of which the emission radiation of the luminescent substance is attenuated. Possible luminescent substances are, for example, inorganic pigments doped with erbium, organometallic complexes with erbium and/or specific organic dyes.

In a further embodiment, the primary emission radiation of the luminescent substance lies in the range between 1600 nm and 1850 nm. In this embodiment, compared to luminescent substances with primary emission radiation in a wavelength range below 1600 nm, a further reduced scatter loss can be recognized when the security element layer composite is applied on a value document substrate which comprises paper. However, both the detector (sensor) and the detection method are more complex. In addition, it is preferred to employ other materials, namely inorganic pigments doped with thulium and/or organometallic complexes with thulium

In one embodiment, the primary emission radiation of the luminescent substance lies in a wavelength range between 1850 nm and 2100 nm. When employing the security element layer composite in combination with a value document substrate which comprises paper, compared to luminescent substances with primary emission below 1850 nm are very low, but the detector and the detection method seem elaborate and complex. It should further be noted that vibrational overtones of water lie in this wavelength range, so that the intensity of the luminescent substance also varies with the moisture content of the substrate, whereby the detection becomes more elaborate again. Luminescent substances which have a primary emission radiation in a wavelength range between 1850 nm and 2100 nm are, for example, inorganic pigments doped with holmium and/or organometallic complexes with holmium.

In addition to the dopants mentioned here, further dopants can be provided which, in combination with the rare earth ion, make possible an energy transfer to it, for example erbium. Further, the dopants, such as neodymium, ytterbium, erbium, thulium and/or holmium, can be present in combination with one another and/or in combination with the other dopants mentioned in order to adjust and/or omit energy transfer and their respective decay time.

In a preferred embodiment, the luminescent substance is a phosphorescent luminescent substance. In this case, in addition to the spectral excitation and emission behavior, a time behavior, in particular the rise or decay time, of the emission radiation of the luminescent substance can be specified and utilized for the authenticity check. This provides increased security, since a forger would have to imitate the time behavior of the luminescent substance. In addition, an increased number of codings is possible, namely in the differentiation of the security element layer composites employed with different rise or decay times.

In one embodiment, the luminescent substance has a decay time of less than 5000 μs, particularly preferably less than 2000 μs, in particular preferably less than 1000 μs. This allows a more precise measurement of the respective decay time even at high transport speeds of the security element layer composite during checking. This is the case, for example, with high-speed sensors for bank notes, where bank notes typically move through the machine at up to 12 meters per second.

The luminescent substance preferably has a decay time of more than 50 μs, particularly preferably more than 80 μs, in particular preferably more than 100 μs. With shorter decay times, a differentiation of background fluorescences, e.g. of organic contaminants, becomes increasingly difficult.

In one embodiment, the luminescent substance has no or hardly any verifiable, i.e. less than 5% of the relative intensity, additional anti-Stokes emission. It can thus be prevented that the security element layer composite can be made visible in the human visual wavelength range by irradiation by means of, for example, lasers or other devices for detecting upconversion.

In one embodiment, it can be provided that the security element layer composite has a further luminescent substance. The further luminescent substance is configured such that it can be excited in a first wavelength range and has an emission in a second wavelength range that corresponds to the wavelength range for excitation of the luminescent substance, wherein the emission radiation of the further luminescent substance corresponds to the wavelength range for excitation of the luminescent substance and excites it to luminescence The further luminescent substance thus serves as an intermediate stage for exciting the luminescent substance. For this purpose, the further luminescent substance preferably has a high Stokes shift or a high anti-Docket Stokes shift. The luminescent substance and further luminescent substance can be arranged in a common layer and/or in different layers of the security element layer composite.

The luminescent substance can be an organic or organometallic luminescent substance, for example fluorescent organic molecules or phosphorescent organometallic complexes. This makes it particularly easy to introduce into polymers and into thin layers, since, for example, the substances can be distributed molecularly in it and there are thus no problems caused by too large pigment grain sizes.

In a preferred embodiment, these are organometallic complexes. These generally exhibit narrower, more specific emission bands and a large Stokes shift. This makes excitation and detection easier. In particular, the separation of the emission radiation from the excitation radiation and from interference signals is facilitated. The organometallic complexes are preferably rare earth complexes, particularly preferably rare earth complexes of the rare earths neodymium, ytterbium, erbium, thulium, holmium or combinations of these of two or more rare earths.

In one embodiment it can be provided that the luminescent substance has a small Stokes shift with regard to wavelength ranges of excitability and emission.

In a further embodiment, the luminescent substance is an inorganic luminescent substance. For example, these are doped inorganic matrices (host lattices). Further, the dopants can be the rare earths neodymium, ytterbium, erbium, thulium, holmium or the transition metals vanadium, chromium, manganese, iron. In addition to the dopants mentioned, other dopants can also be present, e.g. to adjust the decay time of the luminescent substance and/or to make use of energy transfers between the rare earth ion and/or the transition metal and the further dopant.

Suitable inorganic matrices according to the prior art are, for example:
oxides, in particular tri- and tetravalent oxides such as titanium oxide, aluminum oxide, iron oxide, boron oxide, yttrium oxide, cerium oxide, zirconium oxide, bismuth oxide, as well as more complex oxides such as garnets, including, inter alia, e.g. yttrium iron garnets, yttrium aluminum garnets, gadolinium gallium garnets; perovskites, including, inter alia, yttrium aluminum perovskite, lanthanum gallium perovskite; spinels, including, inter alia, zinc aluminum spinels, magnesium aluminum spinels, manganese iron spinels; or mixed oxides such as ITO (indium tin oxide);
oxyhalides and oxychalcogenides, in particular oxychlorides such as yttrium oxychloride, lanthanum oxychloride; as well as oxysulfides, such as yttrium oxysulfide, gadolinium oxysulfide;
sulfides and other chalcogenides, e.g. zinc sulfide, cadmium sulfide, zinc selenide, cadmium selenide;
sulfates, in particular barium sulfate and strontium sulfate;
phosphates, in particular barium phosphate, strontium phosphate, calcium phosphate, yttrium phosphate, lanthanum phosphate, as well as more complex phosphate-based compounds such as apatites, including, inter alia, calcium hydroxyl apatites, calcium fluorapatites, calcium chlorapatites; or spodiosites, including e.g. calcium fluorospodiosites, calcium chlorospodiosites;
silicates and aluminosilicates, in particular zeolites such as zeolite A, zeolite Y; zeolite-related compounds such as sodalites; feldspars such as alkali feldspars, plagioclases; and/or
further inorganic compound classes such as vanadates, germanates, arsenates, niobates, tantalates.

In one embodiment, the security element layer composite can comprise, in addition to the luminescent substance, further luminescent substances, in particular according to one of the luminescent substances described here.

In a further preferred embodiment, the at least one luminescent substance of the security element layer composite is an inorganic luminescent substance. In this way, for example, when employing several luminescent substances, the simultaneous detection of the luminescent substances is facilitated, since their behavior can be better matched to one another, in particular in their decay time of the phosphorescence and/or width of the emission.

According to one aspect, the at least one luminescent substance can have a grain size (D99) of less than 15 μm. The grain size (D99) amounts to preferably less than 8 μm, particularly preferably less than 5 μm. It has surprisingly been found that with a smaller grain size, the trouble-free introduction of the luminescent substance into the security element layer composite is easier. For example, when it is introduced into the adhesive layer with a thickness of 5 μm, a grain size of 5 μm or less is also advantageous, since otherwise the layers above or below the adhesive layer can be adversely affected by the protruding luminescent substance. The specification of the grain size D99 means that 99% of the particles employed in the layer, for example in the adhesive layer and/or in the luminescent substance layer, have a maximum grain size, for example 5 μm.

The concentration of the luminescent substance preferably amounts to less than 5 percent by weight of the material in which it is contained, particularly preferably less than 1 percent by weight. If, for example, the luminescent substance is introduced into the adhesive of an adhesive layer and/or into the adhesive layer, then particularly preferably less than 1 percent by weight of the adhesive is composed of the luminescent substance. This can be achieved by using a particularly efficient luminescent substance. This ensures that the function of the material in the security element layer composite, here e.g. the adhesive effect of the adhesive, is not adversely affected by the luminescent substance.

In a preferred embodiment, the luminescent substance has a coating and/or a functionalization in order to improve its introduction. For example, an inorganic luminescent substance can be supplied with an organic shell or an organic surface functionalization in order to make possible or improve a dispersion of the luminescent substance in a polymer layer or the adhesive layer.

In a preferred embodiment, the luminescent substance has a similar, preferably the same, refractive index as the material surrounding it, for example a polymer layer and/or the adhesive layer. The refractive indices preferably differ from one another by less than 30%, particularly preferably by less than 10%. This ensures that the introduction of the luminescent substance does not lead to optical effects such as cloudiness, etc., which can adversely affect the functionality of the security element layer composite.

If the refractive index of the luminescent substance n₀ deviates significantly from the refractive index of the surrounding material n₂, this can lead to optical effects such as cloudiness. In order to minimize such cloudiness, the luminescent substances can be supplied with a coating with the refractive index n₁≈\sqrt{n₀n₂} with a defined thickness. The coating thickness must be adapted such that the light rays reflected on the luminescent substance and on the coating are mutually destructively superimposed, if possible with a phase difference of π, in the spectral range of the highest eye sensitivity (approx. 555 nm).

In one embodiment, the refractive index of the adhesive layer can be matched by clouding materials or doping such that its refractive index is increased. For example, cloudiness of the adhesive layer, the layer of luminescent substance and/or of the matrix and/or layer surrounding the luminescent substance can be increased with corresponding materials, such as TiO₂ or other oxides, and the scattering can preferably be reduced.

In one embodiment, the functional layer has reflective properties. For this purpose, the functional layer can be configured with a reflective surface, preferably on the side of the functional layer which is opposite the upper side, or can have a coating on the upper side of the functional layer. The reflective property relates in particular to electromagnetic rays in a wavelength range of the excitability and/or the emission radiation of the luminescent substance of the security element layer composite. The luminescent substance is arranged below, i.e. on the side of the functional layer that is opposite the upper side. The reflection of the reflective surface causes an increase in the intensity of the excitation radiation from the lower side onto the luminescent substance, since e.g. scattered excitation radiation can impinge on the luminescent substance several times, and thus causes an increase in the intensity of the emission radiation of the luminescent substance on the lower side of the security element layer composite. Further, the reflective property of the functional layer causes the emission radiation of the luminescent substance to be reflected towards the upper side, so that emission of the luminescent substance in regions in which the functional layer has reflective properties is prevented or reduced on the upper side of the security element layer composite. Further, the reflection of the emission radiation of the luminescent substance causes an increase in intensity towards the lower side of the security element layer composite.

The functional layer can have the reflective property over the entire areal surface of the functional layer (with the exception of the end faces). Further, only one areal side of the functional layer can comprise reflective properties. In addition, the reflective property can also only extend over a (partial) area of the functional layer in certain regions and can be configured as a pattern, for example. The functional layer can have a reflective coating, a reflective print and/or a reflective partial layer. For example, the functional layer can be configured as a reflective metal layer and/or have a reflective metal coating. The metal layer and/or the metal coating is preferably arranged on the side of the functional layer which is opposite the viewer and thus the upper side of the security element layer composite. For example, the metal layer and/or metal coating is an aluminum and/or chromium-based layer or coating.

In one embodiment, the functional layer developing the optically variable effect can be constituted as a reflective embossed structure, in particular a diffractive structure and/or a reflective microstructure, and/or have transparent highly refractive layers, thin-film elements with a color shift effect, in particular with a reflective layer and a semitransparent layer and a dielectric layer arranged in between, layers of liquid crystalline material, in particular of cholesteric liquid crystalline material, printing layers based on effect pigment compositions with viewing angle-dependent effect or with different colors and/or a multilayer structure, for example two semitransparent layers and a dielectric layer arranged between the two semitransparent layers.

In one embodiment, the functional layer of the security element layer composite has an embossing lacquer, for example for forming an embossed structure. In addition, the embossing lacquer of the security element layer composite can already have an embossed structure. In one embodiment, the luminescent substance can be configured in the embossing lacquer, wherein the embossing lacquer on the upper side of the security element layer composite is preferably configured to be reflective and/or absorbent for the emission radiation of the first luminescent substance.

In one embodiment, the security element layer composite can have a scattering layer with light-scattering properties. The intensity of the excitation radiation experienced by the luminescent substance is increased with the aid of the scattering layer. The scattering layer can be configured as a foil with embedded reflective interfering particles. The scattering layer can be configured, for example, as a polymer layer with embedded cellulose fiber and/or with highly refractive inorganic scattering bodies, for example TiO₂ and/or ZrO₂. In one embodiment, the scattering layer is arranged adjacent to the layer in which the luminescent substance is arranged, for example the adhesive layer or luminescent substance layer. Further, it can be provided in one embodiment that the luminescent substance is arranged in the scattering layer and/or the scattering layer is part of the functional layer. In one embodiment, the scattering layer can be arranged between the adhesive layer and the luminescent substance layer.

Further, plastic layers can be used to adjust the thickness of the security element layer composite, to match the distances between different layers of the security element layer composite, and/or to influence other properties of the security element layer composite, such as, for example, the opacity, the color and/or the deformability of the security element layer composite. There are often several layers of plastic directly behind one another, e.g. in the form of foils laminated together. Further, the security element layer composite can comprise an embossing lacquer, a protective lacquer, a primer, a printing layer and/or further security elements or a combination of the features mentioned here.

In a further preferred embodiment, the luminescent substance is located in an adhesion promoter layer or in a primer of the security element layer composite. In a further preferred embodiment, the luminescent substance is located in the adhesive layer. In these cases, the introduction of the luminescent substance into the security element layer composite is particularly simple and significantly less prone to errors. For example, the introduction and homogeneous dispersion of an inorganic luminescent substance in an adhesive (e.g. by stirring in) is easier than in a plastic layer, since if the luminescent substance was introduced into the polymer melt of an extrusion blow-molding of a foil, the manufacturing process could be impaired. Of course, a combination of the different ways of arranging the at least one luminescent substance or various, optionally complementary luminescent substances, for example the further luminescent substance and/or luminescent substances introduced to verify individual layers, is possible, in particular with regard to its layers. A special evaluation of the detected radiation with regard to the spectral range can be employed, for example, to detect the structure or the layer sequence of the security element layer composite. For this purpose, scattering behavior and/or luminescence behavior of a value document substrate, for example a paper layer on which the security element layer composite is applied, can also be taken into account.

The luminescent substance can be arranged in the functional layer and/or adhesive layer at least only in certain regions, for example in the form of a pattern. In one aspect, the pattern can be a coding, in particular a bar code and/or a 2D coding, for example a QR code or a data matrix code. It is thus possible to obtain data and/or a further authentication with regard to the evaluation of the data and/or the pattern from the emission radiation in addition to the authentication based on the emission radiation of the luminescent substance. The opacity of the security element layer composite can extend beyond the pattern of the luminescent substance or the area formed by the luminescent substance and thus can completely cover the luminescent substance. In an alternative, it can also be provided that the opacity of the security element layer composite only partially covers the pattern of the luminescent substance or the area formed by the luminescent substance and at least a partial region of the security element layer composite is configured so that emission radiation of the luminescent substance exits from the upper side of the security element layer composite. The opacity of the security element layer composite can extend in the form of a pattern in the security element layer composite so that it forms a common pattern, in particular a coding, with the distribution of the luminescent substance, in particular the pattern of the luminescent substance or the area formed by the luminescent substance. In one embodiment, the opaque areal region of the security element layer composite can be configured so as to form an optically variable effect as above and, for example, comprise a hologram and/or an embossed pattern and/or can be configured as a line, in particular a line grid, as an areal pattern and/or as a metalized area with demetalization and cover the arrangement of the luminescent substance in incident light onto the upper side at least in an overlap region. Accordingly, it can be provided that the security element layer composite in incident light onto its upper side has at least one region in which the security element layer composite is not configured to be opaque to the emission radiation of the luminescent substance. The security element layer composite is thus configured such that the security element layer composite in incident light onto the upper side of the security element layer composite has regions where the emission radiation of the luminescent substance can exit in a non-detectable or hardly detectable manner, and has regions in which the emission radiation of the luminescent substance can exit.

In one embodiment, the security element layer composite has a peel-off protection. Here, the luminescent substance is arranged in a layer of the security element layer composite which is suitable for remaining entirely or partly on the value document when the security element layer composite is peeled off or detached from the value document. This can be, for example, a specially prepared adhesive layer between the security element layer composite and the value document substrate. When the security element layer composite is peeled off, for example to produce a forgery, the security element layer composite thus no longer contains any or only a small amount of luminescent substance and is therefore recognized as false. The value document still contains the layer with the luminescent substance of the security element layer composite, but no longer the layer with the optically variable effect, preferably no longer the reflective or absorbent layer, so that the intensity of the detectable emission radiation on the side on which the entire security element layer composite was originally attached, is now higher, and now appears weak on the opposite side. Accordingly, improper removal (forgery) of the security element layer composite can be recognized.

In a further aspect, a value document is made available. The value document comprises an areal value document substrate and a security element layer composite which is arranged on an upper side of the areal value document substrate. The security element layer composite has a functional layer which, when viewed in incident light onto an upper side of the functional layer, develops an optically variable effect for a viewer, wherein the upper side then faces the viewer. The security element layer composite further comprises an adhesive layer. The security element layer composite has an upper side facing the viewer and a lower side facing the value document substrate and lying opposite the upper side. The security element layer composite also has at least one first luminescent substance. The first luminescent substance can be arranged in the adhesive layer and/or in a first luminescent substance layer, which is preferably arranged on the side of the functional layer in the security element layer composite which is opposite the upper side of the security element layer composite. The adhesive layer is arranged on the side of the security element layer composite and the functional layer which is opposite the upper side of the security element layer composite. The security element layer composite is arranged on an upper side of the value document substrate in such a manner that the functional layer developing the optically variable effect is aligned such that the optically variable effect can be recognized in incident light onto an upper side of the value document and the security element layer composite in incident light onto a lower side of the value document is covered at least in certain regions, preferably completely. When viewed from the lower side of the value document, more than 10% of the area of the security element layer composite is preferably covered by the value document substrate. This makes possible a mechanically secure anchoring of the security element layer composite and an attractive design and a high level of protection against forgery through various optical impressions of the security element from the upper side and lower side of the value document.

The security element layer composite and the value document substrate can overlap completely or only partially, for example in a window region of the value document substrate.

The first luminescent substance has a primary emission radiation in a wavelength range between 700 nm and 2100 nm. Further, the first luminescent substance can be excited by an excitation radiation in a wavelength range between 400 nm and 2100 nm, preferably between 700 nm and 2100 nm. The functional layer is opaque with respect to the emission radiation of the first luminescent substance. The structure and the security specifications for this are simple and clear, so that a simple check of the security element layer composite and of the value document is possible. The opacity of the functional layer can be made available by a partial layer of the functional layer. It is particularly preferred that the first luminescent substance is arranged in the security element layer composite in such a manner that it is arranged below the layer which makes available the opacity of the functional layer, i.e. that the luminescent substance is arranged at least on the side of the opaque layer which lies opposite the upper side of the security element layer composite.

The functional layer is accordingly configured in such a manner that it hinders the radiation emitted by the first luminescent substance in a wavelength range from 700 nm to 2100 nm to such an extent that it does not pass through the functional layer or only to a significant, small extent and thus is not or hardly detectable on the upper side of the security element layer composite. The functional layer can thus be configured to be absorbent or attenuating, preferably reflective, for the emission range of the first luminescent substance. If the functional layer is configured to be attenuating, a degree of attenuation of at least 50%, preferably of at least 70%, particularly preferably of at least 100%, is provided. The degree of reflection preferably amounts to more than 50%, particularly preferably more than 80%.

The intensity of the emission radiation of the first luminescent substance contained in the security element layer composite is therefore higher on the side of the value document which does not carry the security element layer composite than on the side of the value document which carries the security element layer composite, preferably higher by at least 50%, particularly preferably at least by 70%, further preferably by at least 100%. This achieves increased security against forgery, since the first luminescent substance has better camouflage, the security element layer composite has no detectable luminescence when the security element layer composite is measured directly from its upper side, it cannot be counterfeited through a luminescent imprint or elements luminescing all over, and the effort involved in imitating is very high.

The first luminescent substance is preferably excited from the lower side of the security element layer composite, in particular from the lower side of the value document or of the value document substrate. After excitation, the first luminescent substance emits emission radiation. This runs through the security element layer composite up to the functional layer and preferably does not or hardly penetrate through the functional layer. The emission radiation of the first luminescent substance is not or only hardly recognizable on the upper side of the security element layer composite. In contrast, the emission radiation can advance to the lower side of the security element layer composite and thus also into the value document substrate. The value document substrate is preferably configured such that the emission radiation of the first luminescent substance substantially penetrate through the value document substrate, i.e. taking into account any scattering losses that may be present, a high proportion of the emission radiation, in particular a proportion sufficient for detection, penetrates through the value document substrate, whereby the emission radiation of the first luminescent substance can be ascertained.

The areal region of the value document occupied by the security element layer composite, but at least the areal region occupied by the first luminescent substance, can thus be recognized. In the event of a forgery of the value document, the security element layer composite could only be partially removed. With the removal, the forger could also remove at least part of the first luminescent substance from the authentic value document. When checking the value document with regard to completeness of the security element layer composite, it would be recognizable from the areal intensity distribution of the emission radiation of the first luminescent substance that of the authentic value document only a partial region of the area of the security element layer composite that would normally be present is covered by the security element layer composite.

As a further advantage of the invention, the first luminescent substances cannot or can hardly be detected from the upper side of the security element layer composite. Rather, in particular a detection of the lower side of the security element layer composite and thus from the value document substrate is possible. The security element layer composite would usually not be recognized by forgers as being machine-readable or as being luminescent, since detection typically takes place from the upper side, but not from the lower side.

Further, a forger could remove the security element layer composite from the value document in such a manner that at least part of the functional layer, which relates to the optically variable effect, is removed, wherein at least part of the first luminescent substances remain on the value document substrate. To check the integrity of the value document, an area check of the intensity profile in incident light onto the upper side of the value document with regard to the emission of the first luminescent substances could be utilized, wherein on the upper side of the value document in the region that typically has the security element layer composite, emission radiation from the remaining first luminescent substance would be partially recognizable. In the case of an intact security element layer composite, no or a small but substantially homogeneously distributed emission radiation of the first luminescent substance would be recognizable.

With the value document according to the invention, it is possible to check not only the authenticity of the value document and of the security element composite, but also their integrity.

The security element layer composite employed in the value document can be made available by a security transfer element, as described above.

The value document substrate on which the security element layer composite is arranged can be composed of paper, plastic or a composite of paper and plastic. However, the value document is preferably bank note paper/cotton paper or a composite material containing such paper.

The value document substrate is typically 50-100 μm thick and, for example in the case of a bank note of paper, is composed typically mainly of cellulose fibers, inorganic fillers such as e.g. titanium dioxide and organic aids, such as CMC (carboxymethyl celluloses). The fillers produce a high degree of scattering of the value document substrate and thus an attractive white color impression. In addition, they make possible good excitation of the first and/or second luminescent substance, since a high capture cross-section of the luminescence centers of the first and/or second luminescent substance is ensured. Further, the value document substrate can comprise at least one plastic foil (for example polymer bank note), but preferably a composite of at least two plastic foils. Value document substrates with a plastic foil can have a higher transparency, whereby an easier excitation of the first luminescent substances is possible. The value document substrate can, however, also have a more complex structure, and e.g. in the case of a composite material that contains at least one plastic foil or a plastic core that is surrounded by at least two layers of paper, or can contain at least one layer of paper that is surrounded by at least two plastic foils (so-called hybrid bank notes).

The value document substrate thus forms the base body of the value document and, due to its thickness and its scattering and absorption properties, is a relevant factor for weakening the excitation radiation and emission radiation of the luminescent substances employed in the context of the invention, in particular the first luminescent substance, which has to traverse the value document substrate respectively.

In one embodiment, at least the mean intensity of the emission radiation of the first luminescent substance of the security element layer composite on the lower side of the value document is significantly higher than on the upper side of the value document, in each case in the areal region of the security element layer composite, wherein in this region preferably no or a negligible emission radiation of the first luminescent substance can be recognized on the upper side of the value document. The functional layer and/or layers above the first luminescent substance are configured for the emitted radiation of the first luminescent substance in such a manner that they hinder penetration. An attenuation of at least 50% is considered significant. The functional layer can thus be configured to be absorbent or attenuating, preferably reflective, for the emission range of the luminescent substance. An attenuating execution of the functional layer offers the advantage that the attenuation in the infrared emission range of the luminescent substance can be produced independently of the visual impression, so that there is great freedom in the design of the visual impression of the security element layer composite. On the other hand, a reflective execution can itself act as an attractive design feature and is a necessary part of some optically variable elements such as a hologram. If the functional layer is configured to be attenuating, a degree of attenuation of at least 50%, preferably of at least 70%, particularly preferably of at least 100%, is provided. The degree of reflection preferably amounts to more than 50%, particularly preferably more than 80%. A secure check of the value document and/or the security element layer composite for forgery and/or for a snippet counterfeit, meaning that a region of an authentic value document has been removed and optionally replaced by a false region, is possible.

In one embodiment it can be provided that the value document substrate has at least one second luminescent substance. The at least one second luminescent substance can be arranged in the value document substrate, for example in a paper substrate layer and/or in a polymer layer. For this purpose, the second luminescent substance is added, for example, to the paper pulp in a paper machine for producing the paper substrate layer. If the value document substrate comprises a polymer layer, the second luminescent substance can be admixed in an extruder. Of course, the value document substrate can also comprise a combination of paper substrate and polymer layer. Further, the second luminescent substance can be configured in a printing layer on the value document substrate. The second luminescent substance can be introduced in a printing ink.

With the aid of the second luminescent substance, a full-area protection of the value document is achieved particularly well.

Further, it can be prevented that the security element layer composite is removed from the value document substrate by detachment with solvents and is applied to a forged value document substrate in order to make it appear authentic (for example to a modified deed or a bank note with a higher denomination). The at least first luminescent substance in the security element layer composite and the at least second luminescent substance in and/or on the value document substrate are preferably coordinated with one another.

In one embodiment of the value document, the first and optionally the second luminescent substance are configured such that their excitability by excitation radiation is in the visible spectral range, in particular preferably in the wavelength range between 400 nm and 700 nm. When employing such excitation radiation for excitation by a value document substrate which comprises paper, for example, higher scattering losses occur in the value document substrate and a higher susceptibility to interfering factors such as dirt, but the range of usable substances is expanded, for example pigments, dyes and complexes that can be excited with visible radiation. The losses can, however, be more than compensated in part by using the generally stronger excitation sources present for this spectral range.

In one embodiment, the first and second luminescent substances can be excited in the same wavelength range, for example in the visual and/or infrared wavelength range. This makes a check of both luminescent substances possible with a space-saving and energy-saving sensor that only makes available excitation light of one wavelength.

In one embodiment, the first and/or optionally second luminescent substance of the value document are configured such that their excitability by excitation radiation lies in the infrared range, in particular preferably in the wavelength range between 700 nm and 2100 nm. In a particularly preferred embodiment, both the excitation radiation and the emission lie in the infrared range. This avoids the scattering losses that typically occur in the case of a value document substrate which comprises paper, for example. In addition, absorptions that often occur due to soiling, for example, are often more permeable to electromagnetic radiation in the infrared range than in the visible range.

In one aspect of the invention, the primary emission radiation of the first and/or optionally second luminescent substance of the value document is in a wavelength range between 900 nm and 2100 nm. As a result, the luminescence of the security element layer composite cannot be perceived by the human eye, whereby greater security is achieved. Further, due to the dependence of the scatter coefficient of the value document substrate on the wavelength of the emission radiation, the security element layer composite on the value document substrate, which preferably contains paper, experiences fewer scattering losses, so that the emission radiation of the first and/or optionally second luminescent substance can penetrate through the value document substrate with fewer losses.

In one aspect, the primary emission radiation of the first and/or optionally luminescent substance lies in a wavelength range between 900 nm and 1300 nm. Detectors of simple structure are already available for the detection of emission radiation in this wavelength range, so that no complex detectors have to be employed. A compromise is thus achieved between simple detectability and scattering losses. For example, the first and second luminescent substances with a wavelength range of the primary emission radiation between 900 nm and 1300 nm are doped inorganic pigments with the dopants neodymium or ytterbium or doped with specific transition metals and organometallic complexes with neodymium or ytterbium and/or organic dyes, such as cyanine dyes, thiopyrylium dyes such as IR-1061 and/or indolium dyes such as IR-1048. In one embodiment, a combination of neodymium and ytterbium can also be provided. In one embodiment, a combination of neodymium and ytterbium can also be provided.

In a further aspect, the primary emission radiation of the first and/or optionally second luminescent substance lies in a wavelength range between 1300 nm and 1600 nm. In comparison with a wavelength range below 1300 nm, there are again reduced scattering losses in a paper substrate in the case of a value document substrate and the detectors can still be constructed relatively simply. However, in the case of cellulose-based substrates of the value document substrate, there can be a broad absorption band due to a superposition of various O—H stretching vibrations, as a result of which the emission radiation of the first and/or optionally the second luminescent substance is attenuated. As the first and/or optionally second luminescent substance, there are conceivable, for example, inorganic pigments doped with erbium, organometallic complexes with erbium and/or specific organic dyes.

In a further embodiment, the primary emission radiation of the first and/or optionally second luminescent substance lies in the range between 1600 nm and 1850 nm. In this embodiment, compared to luminescent substances with primary emission radiation in a wavelength range below 1600 nm, scattering losses are again reduced in the value document substrate which comprises paper. However, both the detector and the detection method are more complex. In addition, it is preferred to employ different materials, namely inorganic pigments doped with thulium and/or organometallic complexes with thulium.

In one embodiment, the primary emission radiation of the first and/or second luminescent substance lies in a wavelength range between 1850 nm and 2100 nm. When employing the security element layer composite in combination with the value document substrate, which preferably comprises paper, compared to luminescent substances with primary emission below 1850 nm are very low, but the detector and the detection method would be more elaborate and complex. A further disadvantage is that in this wavelength range there are oscillation overtones of the water, so that the intensity of the first and/or optionally the second luminescent substance also varies with the moisture content of the substrate, whereby the detection becomes more elaborate again. The first and/or optionally second luminescent substance which have a primary emission radiation in a wavelength range between 1850 nm and 2100 nm are, for example, inorganic pigments doped with holmium and/or organometallic complexes with holmium.

In addition to the dopants mentioned here, further dopants can be provided which, in combination with the rare earth ion, make possible an energy transfer thereto, for example erbium. Further, the dopants, such as neodymium, ytterbium, erbium, thulium and/or holmium, can be present in combination with one another and/or in combination with the other dopants mentioned in order to adjust and/or omit energy transfer and their respective decay time.

In one embodiment, the first and second luminescent substances at least partially overlap in a wavelength range of their emission radiation; in particular, the emission wavelength range of the second luminescent substance can coincide with that of the first luminescent substance. As a result, the first luminescent substance of the security element layer composite can no longer or only with difficulty be examined independently of the second luminescent substance of the value document substrate, which is preferably present over the full area.

In one embodiment, it can be provided that the wavelength ranges of the emission of the first and second luminescent substance complement one another and/or overlap in certain regions. With the aid of a spectrally resolving detector, the supplementary spectrum can additionally be utilized as security verification, in particular whether the first and second luminescent substances are present in the detected areal region. The supplementary and optionally overlapping spectrum can be established with the aid of the amount and the type of the first and second luminescent substances employed.

In a further embodiment, the first and second luminescent substances luminesce in different spectral ranges. A higher number of separable codings are achieved thereby. Further, a separate evaluation of the emissions is easier.

In a preferred embodiment, the first and/or second luminescent substance phosphoresce. In this case, in addition to the spectral excitation and emission behavior, the decay time of the respective emission can also be specified. This provides increased security, since a forger would have to imitate the time behavior. In addition, an increased number of codings is possible, namely in the differentiation of the security element layer composites with different rise or decay times.

In one embodiment, the first and/or second luminescent substance have a decay time of less than 5000 μs, particularly preferably of less than 2000 μs, in particular preferably of less than 1000 μs. This allows a more precise measurement of the respective decay time even at high transport speeds of the value document. This is the case, for example, with high-speed sensors for bank notes, where bank notes typically move through the machine at up to 12 meters per second.

Preferably, the first and/or second luminescent substance has a decay time of more than 50 μs, particularly preferably of more than 80 μs, in particular preferably of more than 100 μs. With shorter decay times, a differentiation of background fluorescences, e.g. of organic contaminants, becomes increasingly difficult.

In one embodiment, the first and second luminescent substances are based
on neodymium or ytterbium or a combination of neodymium and ytterbium, wherein the first luminescent substance preferably differs from the second luminescent substance, and/or
on transition metals with an emission in the wavelength range between 900-1300 nm, wherein the first luminescent substance preferably differs from the second luminescent substance, and/or on erbium, on thulium, and/or
on holmium, wherein the first luminescent substance preferably differs from the second luminescent substance.

Hereby it is achieved that the first and second luminescent substances emit in a similar wavelength range, i.e. both substances emit together in one of the spectral ranges mentioned here, such as 1300 nm-1600 nm, 1600 nm-1850 nm and 1850 nm-2100 nm. By means of the similar wavelength ranges it is achieved in each case that the first and second luminescent substances emit in the same spectral range. Further, security can be increased since it becomes more difficult, particularly in the long-wave ranges, to detect the first and second luminescent substances independently of one another. As an additional advantage, the detector structure becomes simpler, particularly in the short-wave ranges, since only a limited range has to be checked.

In a further embodiment, the first and second luminescent substances are chosen in such a manner that they emit in different spectral ranges. This means that more codings can be produced. Further, the separate evaluation of the emissions is technically easier.

In one embodiment, the first and the second luminescent substance have a common excitation. In a further embodiment, the first and second luminescent substances are excited via the same rare earth ion, but emit via different rare earth ions. For example, the first luminescent substance contains neodymium and the second luminescent substance contains neodymium and ytterbium at the same time. The first luminescent substance is excited in the neodymium and emits via the neodymium. The second luminescent substance is excited in the neodymium and emits via the ytterbium after an energy transfer. As a result, both substances can be excited by a common wavelength, which simplifies the method. Further, security is increased due to more complex luminescent substances.

In one embodiment, the first and second luminescent substances are coordinated with one another in such a manner that the wavelength range of the emission radiation and/or the wavelength range for excitation of the second luminescent substance substantially corresponds to the wavelength range of the emission radiation and/or the wavelength range for excitation of the first luminescent substance of the security element layer composite.

In a further embodiment, the first luminescent substance can have a complementary luminescence behavior to the second luminescent substance. This means that the luminescence of the first luminescent substance differs in its excitation, its emission and/or its decay. As a result, the two luminescent substances can be verified and utilized for the authenticity check separately from one another.

In one embodiment, the first and/or optionally the second luminescent substance have no or hardly any verifiable, i.e. less than 5% of the relative intensity, additional anti-Stokes emission. It can thus be prevented that the value document can be made visible in the human visual wavelength range by irradiation by means of, for example, lasers or other devices for detecting upconversion.

The first and/or optionally second luminescent substance can be organic or organometallic luminescent substances, for example fluorescent organic molecules or phosphorescent organometallic complexes. This makes possible particularly simple introduction into polymers and thin layers, since, for example, the substances can be molecularly distributed therein, and thus no problems with excessively large pigment grain sizes come about.

In a preferred embodiment, the first and/or optionally the second luminescent substance is/are organometallic complexes. These generally show narrower, more specific emission bands and a large Stokes shift. This makes excitation and detection easier. In particular, the separation of the emission radiation from the excitation radiation and from interference signals is facilitated. The organometallic complexes are preferably rare earth complexes, particularly preferably rare earth complexes of the rare earths neodymium, ytterbium, erbium, thulium, holmium.

In a further embodiment, the first and/or optionally the second luminescent substance is an inorganic luminescent substance/are inorganic luminescent substances. For example, these are doped inorganic matrices (host lattices). Further, the dopants can be the rare earths neodymium, ytterbium, erbium, thulium, holmium or the transition metals vanadium, chromium, manganese, iron. In addition to the dopants mentioned, further dopants can also be present, e.g. to adjust the decay time of the first and/or optionally second luminescent substance or to make use of energy transfers.

Suitable inorganic matrices according to the prior art are, for example:
oxides, in particular tri- and tetravalent oxides such as titanium oxide, aluminum oxide, iron oxide, boron oxide, yttrium oxide, cerium oxide, zirconium oxide, bismuth oxide, as well as more complex oxides such as garnets, including, inter alia, e.g. yttrium iron garnets, yttrium aluminum garnets, gadolinium gallium garnets; perovskites, including, inter alia, yttrium aluminum perovskite, lanthanum gallium perovskite; spinels, including, inter alia, zinc aluminum spinels, magnesium aluminum spinels, manganese iron spinels; or mixed oxides such as ITO (indium tin oxide);
oxyhalides and oxychalcogenides, in particular oxychlorides such as yttrium oxychloride, lanthanum oxychloride; as well as oxysulfides, such as yttrium oxysulfide, gadolinium oxysulfide;
sulfides and other chalcogenides, e.g. zinc sulfide, cadmium sulfide, zinc selenide, cadmium selenide;
sulfates, in particular barium sulfate and strontium sulfate;
phosphates, in particular barium phosphate, strontium phosphate, calcium phosphate, yttrium phosphate, lanthanum phosphate, as well as more complex phosphate-based compounds such as apatites, including, inter alia, calcium hydroxyl apatites, calcium fluorapatites, calcium chlorapatites; or spodiosites, including e.g. calcium fluorospodiosites, calcium chlorospodiosites;
silicates and aluminosilicates, in particular zeolites such as zeolite A, zeolite Y; zeolite-related compounds such as sodalites; feldspars such as alkali feldspars, plagioclases; and/or
further inorganic compound classes such as vanadates, germanates, arsenates, niobates, tantalates.

In a further preferred embodiment, the first and/or optionally the second luminescent substance is an inorganic luminescent substance. This facilitates the simultaneous detection of the luminescent substances, since their behavior can be better matched to one another, in particular with respect to their decay time of the phosphorescence and/or the width of the emission.

In one embodiment, the first luminescent substance of the security element layer composite and/or the second luminescent substance of the value document substrate can comprise at least two of the luminescent substances described here.

In a preferred embodiment, the first luminescent substance is an organic or organometallic luminescent substance and the second luminescent substance is an inorganic luminescent substance, or vice versa. In general, however, inorganic luminescent substances are better suited for full-area introduction into the value document substrate, in particular into a paper layer of cellulose-based value documents.

According to one aspect, the first and second luminescent substances can have a grain size (D99) of less than 15 μm. The grain size (D99) preferably amounts to less than 8 μm, particularly preferably less than 5 μm. It has surprisingly been found that with a smaller grain size, the trouble-free introduction of the first and/or optionally second luminescent substance into the security element layer composite or into the value document substrate is easier. For example, when it is introduced into the adhesive layer with a thickness of 5 μm, a grain size of 5 μm or less is also advantageous, since otherwise the layers above or below the adhesive layer can be adversely affected by the protruding luminescent substance. The specification of the particle size distribution D99 means that 99% of the particles employed in the layer, for example in the adhesive layer and/or in the luminescent substance layer, have a maximum particle size, for example 5 μm.

The concentration of the first and/or optionally the second luminescent substance preferably amounts to less than 5 percent by weight of the material in which it is contained, particularly preferably less than 1 percent by weight. If, for example, the first and/or optionally the second luminescent substance is/are introduced into the adhesive of an adhesive layer and/or into the adhesive layer or into the value document substrate, it is particularly preferred that less than 1 percent by weight of the surrounding material, for example the adhesive, is composed of the first or optionally the second luminescent substance. This can be achieved by using particularly efficient luminescent substances. This ensures that the function of the material in the security element layer composite, here e.g. the adhesive effect of the adhesive, is not adversely affected by the first luminescent substance. In one embodiment it can be provided that the security element layer composite is configured in such a manner that in particular in the adhesive layer poorly adhering areal regions configured with luminescent substances are combined with strongly adhering regions configured without luminescent substances and in particular form a pattern to, for example, describe a targeted detachment behavior of the security element layer composite from the value document substrate and/or to make possible a specific separation of the security element layer composite when the luminescent substances are arranged in an intermediate layer of the security element layer composite, for example in the luminescent substance layer.

In a preferred embodiment, the first luminescent substance has a coating and/or a functionalization in order to improve its introduction. For example, an inorganic luminescent substance can be supplied with an organic shell or an organic surface functionalization in order to make possible or improve its dispersion in a polymer layer or the adhesive layer.

In a preferred embodiment, the first and/or optionally the second luminescent substance have a similar, preferably the same, refractive index as the material surrounding it, for example a polymer layer and/or the adhesive layer. The refractive indices preferably differ from one another by less than 30%, particularly preferably by less than 10%. This ensures that the introduction of the first and/or optionally the second luminescent substance does not lead to optical effects such as cloudiness, etc., which can adversely affect the functionality of the value document, in particular in the region of the security element layer composite.

If the refractive index of the first and/or optionally second luminescent substance n₀ deviates strongly from the refractive index of the material surrounding it n₂, this can lead to optical effects such as cloudiness. In order to minimize such cloudiness, the first and/or optionally the second luminescent substance can be supplied with a coating with the refractive index n₁≈\sqrt{n₀n₂} with a defined thickness. The coating thickness must be adapted such that the light rays reflected on the first and/or optionally second luminescent substance and on the coating are mutually destructively superimposed, if possible with a phase difference of π, in the spectral range of the highest eye sensitivity (approx. 555 nm).

In one embodiment, the functional layer of the security element layer composite has reflective properties. For this purpose, the functional layer can be configured with a reflective surface, preferably on the side of the functional layer which is opposite the upper side. The reflective property relates in particular to electromagnetic rays in a wavelength range of the emission radiation of the first luminescent substance of the security element layer composite. The first luminescent substance is below, i.e. arranged on the side of the functional layer that is opposite the upper side. The reflection of the reflective surface causes an increase in the intensity of the excitation radiation from the lower side onto the first luminescent substance, since, for example, scattered excitation radiation can thus impinge on the first luminescent substance several times and cause an increase in the intensity of the emission radiation of the first luminescent substance on the lower side of the security element layer composite. Further, the reflective property of the functional layer causes the emission radiation of the first luminescent substance to be absorbed towards the upper side, so that the emission of the first luminescent substance is prevented or reduced in regions in which the functional layer has reflective properties.

The functional layer of the security element layer composite can have the reflective property over its entire areal surface (with the exception of the end faces). Further, it is also possible for only one areal side of the functional layer to comprise reflective properties. A full-area execution of the reflective property makes possible the optically variable effect to be easily recognizable over the entire surface of the security element layer composite. In addition, the reflective property can also only extend over an area of the functional layer in certain regions and can be configured as a pattern, for example. The functional layer can have a reflective coating, a reflective print and/or a reflective partial layer. For example, the functional layer can be configured as a reflective metal layer and/or have a reflective metal coating. This is an attractive design element and robust against environmental influences. The metal layer and/or the metal coating is preferably arranged on the side of the functional layer which is opposite the viewer and thus the upper side of the security element layer composite. As a result, the metal layer is protected against abrasion and can have a height profile, for example to form a reflective embossed structure. For example, the metal layer and/or metal coating is an aluminum and/or chromium-based layer or coating.

In one embodiment, the functional layer developing the optically variable effect can be constituted as a reflective embossed structure, in particular a diffractive structure and/or a reflective microstructure, and/or can have transparent highly refractive layers, thin-film elements with a color shift effect, in particular with a reflective layer and a semitransparent layer and a dielectric layer arranged in between, layers of liquid crystalline material, in particular of cholesteric liquid crystalline material, printing layers based on effect pigment compositions with viewing angle-dependent effect or with different colors and/or a multilayer structure, for example two semitransparent layers and a dielectric layer arranged between the two semitransparent layers. For example, the functional layer can have a hologram, micro mirror and/or optically variable color.

In one embodiment, the functional layer of the security element layer composite has an embossing lacquer, for example for forming an embossed structure. In addition, the embossing lacquer of the security element layer composite can already have an embossed structure. In one embodiment, the at least one first luminescent substance can be arranged in the embossing lacquer, wherein the embossing lacquer on the upper side of the security element layer composite is preferably configured to be reflective and/or absorbent for the emission radiation of the first luminescent substance.

Further, plastic layers can be used to adjust the thickness of the security element layer composite, to match the distances between different layers of the security element layer composite, and/or to influence other properties of the security element layer composite, such as, for example, the opacity, the color and/or the deformability of the security element layer composite. There are often several layers of plastic directly behind one another, e.g. in the form of foils laminated together. Further, the security element layer composite can comprise an embossing lacquer, a protective lacquer, a primer, a printing layer and/or further security elements or a combination of the features mentioned here.

In one embodiment, the security element layer composite can have a scattering layer with light-scattering properties. The intensity of the excitation radiation which the first luminescent substance experiences is increased with the aid of the scattering layer. The scattering layer can be configured as a foil with embedded reflective interfering particles. The scattering layer can be configured, for example, as a polymer layer with embedded cellulose fiber and/or with highly refractive inorganic scattering bodies, for example TiO₂ and/or ZrO₂. In one embodiment, the scattering layer is arranged adjacent to the layer in which the first luminescent substance is arranged, for example adhesive layer or luminescent substance layer. Further, it can be provided in one embodiment that the first luminescent substance is arranged in the scattering layer and/or the scattering layer is part of the functional layer.

The value document substrate can likewise comprise at least one scattering layer which is constructed and acts similarly to the scattering layer of the security element layer composite, but with regard to the first and optionally the second luminescent substance. If the value document substrate comprises a plastic layer, this plastic layer can be executed as a scattering layer. For this purpose it preferably contains cellulose fibers and/or fillers, preferably titanium dioxide or carboxymethyl cellulose. This makes possible good excitation of the first and/or second luminescent substance, since a high capture cross section of the luminescent centers of the first and/or second luminescent substance is ensured. Further, a printing layer and/or a printing acceptance layer of the value document substrate can assume the function of a scattering layer.

In one aspect, the value document can have an imprint, for example in the form of a printing layer. The imprint of the value document, e.g. by offset or intaglio printing, produces on both sides of the value document substrate a continuous or only partially present (e.g. halftone printing, line grid, bar code, . . . ) layer of printing inks or pigmented printing lacquers, which is also referred to as the printing ink layer. It typically contains organic or inorganic pigments or organic dyes which absorb strongly in the visible wavelength range and/or in the infrared wavelength range. Although it is very thin relative to the value document substrate, depending on the position of its absorption bands, it can cause a significant weakening of the excitation radiation or emission radiation of the first and/or optionally the second luminescent substance.

In addition to the value document substrate and printing layer, the value document can have a significantly more complex structure and e.g. have an adhesive bonding, a protective lacquer layer or other functional layers, or have other security elements, such as mottling fibers or a watermark.

In one embodiment it can be provided that the printing layer, in particular the positioning of the printing pigments and/or the printing lines, and the security element layer composite are matched to one another. In one aspect it can be provided that no printing pigments and/or printing ink are/is arranged in the regions of the value document in which the security element layer composite is arranged. In a further aspect, the printing pigments and/or printing ink at least partially overlap with the security element layer composite. Printing pigments and/or printing ink and/or printing lines are usually supplied with dyes in the visual spectrum. However, printing pigments and/or printing inks can also be employed which have absorption bands in the infrared range. Depending on the application case, in particular the criteria according to which an authenticity check is carried out on the value document, absorption in the infrared range can have a positive effect, in particular in the NIR (near infrared) wavelength range.

The absorption of the printing pigments and/or the printing ink can be reduced, for example, by halftone printing or similar techniques, which means that not an entire area is printed with printing pigments and/or printing inks, but rather merely a part between the grid lines or grid dots remains unprinted. The proportion of unprinted area directly below the security element layer composite on both sides of the value document substrate is preferably more than 30%, particularly preferably more than 50%, further preferably more than 70%. This achieves a compromise between the imprint and the usability of the security element.

In one embodiment, the absorption spectrum of the printing layer and the emission spectrum of the first luminescent substance are matched to one another. This means that directly below the security element layer composite on both sides of the value document substrate only printing layers are chosen whose absorption bands do not coincide with the excitation radiation or the emission radiation or only interact to a small extent. Alternatively, the excitation and emission radiation of the first luminescent substance are chosen so that they each fall into an absorption gap of the printing layer.

The printing layer preferably absorbs less than 10% of its maximum absorption, particularly preferably less than 5%, in the range of the excitation radiation of the first luminescent substance. The printing layer preferably absorbs less than 10% of its maximum absorption, particularly preferably less than 5%, in the range of the emission radiation of the first luminescent substance.

In one embodiment it can be provided that the positions of the first and second luminescent substances are coordinated with one another. The first and second luminescent substances can be arranged in such a manner that they do not overlap or overlap in a specific pattern. Thus, for example when employing the value document as bank notes, denomination-specific overlap regions and/or patterns can be generated.

In a further preferred embodiment, the first and optionally second luminescent substance are located in an adhesion promoter layer or in the primer of the security element layer composite or of the value document substrate. In a further preferred embodiment, the first luminescent substance is located in the adhesive layer. In these cases, the introduction of the at least first luminescent substance into the security element layer composite is particularly simple and significantly less prone to errors. For example, the introduction and homogeneous dispersion of an inorganic luminescent substance in an adhesive (e.g. by stirring in) is easier than into a plastic layer. For example, introduction into the polymer melt of an extrusion blow-molding of a foil could impair the manufacturing process. In particular, for quality assurance purposes, it can also be verified that the security element layer composite is correctly applied to the value document substrate. This can take place, for example, on an application machine, during final processing and/or during a final check.

The first luminescent substance can only be arranged in certain regions in the functional layer and/or in the adhesive layer, for example in the form of a pattern. In one aspect, the pattern can be a coding, in particular a bar code and/or a 2D coding, for example a QR code or a data matrix code. It is thus possible to obtain data and/or a further authentication with regard to the evaluation of the data and/or the pattern from the emission radiation in addition to the authentication based on the emission radiation of the first luminescent substance. In one embodiment, the first and second luminescent substances can complement each other to form a pattern, so that data can only be obtained or the authenticity of the value document determined when the first and second luminescent substance, in particular their related patterns, are correlated. And the code can contain information about the luminescent substance and/or its properties.

In one embodiment, the security element layer composite has a peel-off protection. Here, the first luminescent substance is arranged in a layer of the security element layer composite which is suitable for remaining entirely or partially on the value document when the security element layer composite is peeled off or detached from the value document. This can be, for example, a specially prepared adhesive layer between the security element layer composite and the value document substrate. When the security element layer composite is peeled off, for example to create a forgery, the security element layer composite thus no longer contains a first luminescent substance and is therefore recognized as false. The value document still contains the layer with the first luminescent substance of the security element layer composite, but no longer the optically variable effect, preferably no longer the reflective or absorbent layer, so that the intensity of the detectable emission radiation on the side on which the entire security element layer composite was originally attached, is now higher, and now only appears still weaker on the opposite side. It can thus be recognized when the security element has been peeled off.

In one embodiment of the value document, the value document substrate has a Kubelka-Munk scatter coefficient with a value between 10 and 80 l/mm in a wavelength range from 400 nm to 2100 nm. It was surprisingly found that such value document substrates have particularly high transmission properties for emission radiation in a wavelength range from 400 nm to 2100 nm. Further, sufficient transmission of the excitation radiation through the value document substrate is ensured, so that the first luminescent substance receives sufficient excitation. In addition, sufficient transmission of the emission radiation of the security element layer composite through the value document substrate is ensured in order to detect said emission radiation on the lower side of the value document. Further, a high degree of scattering of the value document substrate makes possible good excitation of the first and/or second luminescent substance, since a high capture cross section of the luminescent centers of the first and/or second luminescent substance is ensured. With the Kubelka-Munk scatter coefficient of 80 l/ mm in a wavelength range from 400 nm to 2100 nm, a sufficient balancing act has been created between sufficient transmission and high scattering.

In a further aspect, a method for checking a value document according to the invention, as described herein, is disclosed. The method comprises the steps of:
applying to the value document an excitation radiation in incident light onto the lower side of the value document, wherein the excitation radiation comprises the wavelength range of the excitation radiation of the at least one first luminescent substance of the security element layer composite;
detecting an emission, in particular a spectral behavior, a rise and/or a decay behavior of the emission radiation of the first luminescent substance of the security element layer composite on the lower side of the value document over at least one areal region of the value document; and
ascertaining the authenticity of the security element layer composite from the detected emission, in particular from the rise and/or decay behavior of the detected emission.

According to one embodiment it can be provided that the areal region of the value document comprises the region of the security element layer composite and preferably a surrounding region of the security element layer composite which has an area of at least 100% of the area of the security element layer composite. This ensures that the maximum luminescence intensity of the security element layer composite can be detected.

In one embodiment it can be provided that the detected emission, in particular the detected rise behavior and/or the detected decay behavior, results in a preferably two-dimensional pattern over the areal region, and the pattern corresponds to the type of the security element layer composite. This results in increased security against forgery, since the luminescence behavior of the pattern can be related to the visual impression of the security element layer composite.

In one embodiment, it can be provided that at least two areal regions are chosen for the detection of the emission, in particular the spectral, rise and/or decay behavior. Further or in addition, the application of excitation radiation to at least two areal regions can also be provided. The respective areal regions can differ in location and size for both detection and impingement.

In a preferred embodiment, the second luminescent substance which may be present is detected simultaneously with the first luminescent substance. A plausibility check is preferably carried out by means of the intensity of the emission radiation of the first and second luminescent substance. This means that if the intensity of the first luminescent substance is reduced compared to the expected value, for example due to severe soiling of the bank note, the luminescence intensity of the second luminescent substance could also be reduced. Such effects can be taken into account by simultaneously measuring the first and second luminescent substances.

In one embodiment it can be provided that the method further comprises the following steps of:
applying to the value document an excitation radiation in incident light onto the upper side of the value document with excitation radiation, wherein the excitation radiation comprises the wavelength range of the excitation radiation of the first luminescent substance of the security element layer composite;
detecting an emission, in particular a spectral behavior, a rise and/or a decay behavior of the emission radiation, of the first luminescent substance of the security element layer composite on the upper side of the value document over at least one areal region of the value document; and
comparing the emission of the first luminescent substance detected on the upper side and the lower side of the value document for checking the authenticity of the value document, e.g. comparing the respective rise or decay behavior.

Thus, the emission radiation is detected not only on the side of the value document that does not carry the security element layer composite, but on both sides of the value document. This results in a more reliable authenticity check. The emission radiation detected on the respective sides of the value document can be compared with one another. The steps for checking the two sides of the value document can, if necessary with the same checking unit, take place one after the other or take place at the same time, e.g. by using an additional detection device on the opposite side of the value document.

In one embodiment, in addition to the first luminescent substance, the security element layer composite can comprise at least one further luminescent substance, preferably several luminescent substances, and/or, in addition to the second luminescent substance, the value document substrate can comprise at least one further luminescent substance, preferably several luminescent substances. These additional luminescent substances of the value document substrate and/or of the security element layer composite can be substances and/or combinations of the luminescent substances described here and/or have the same composition as the first or second luminescent substance.

The first and optionally the second luminescent substance and/or additional luminescent substance can each be configured such that at least one of the luminescent substances excites another of the luminescent substances with its emission radiation, wherein their excitation wavelength ranges preferably differ at least in certain regions. Thus the existence of several luminescent substances can be verified with just one excitation radiation. The first and optionally the second luminescent substance and/or additional luminescent substance are preferably arranged in different layers and/or at a defined distance from one another in the value document.

For this purpose, the luminescent substances can comprise a combination of at least two of the dopings mentioned here with, for example, rare earth ion and further dopings, wherein the excitation preferably takes place in one doping and, due to an energy transfer, the emission takes place in another doping.

The at least one first and at least one second luminescent substance are preferably configured as particles.

In a further aspect, the invention relates to a checking unit (referred to as a sensor in the example) for checking the value documents for authenticity, denomination and/or fitness. The checking unit has an excitation device for emitting the excitation radiation for the luminescent substances, a detection device for detecting the emission radiation of the luminescent substances and an evaluation device for checking the authenticity of the respective value document based on the detected emission radiation. The checking unit is configured to carry out a method as described above.

In a further aspect, the invention relates to a value document processing apparatus. The value document processing apparatus comprises an interface for feeding value documents, e.g. an input unit for inputting the value documents to be checked into the value document processing apparatus, the above-mentioned checking unit for checking the value documents and at least one output unit for outputting the checked value documents from the value document processing apparatus. Further, one aspect of the invention relates to a system of an above-mentioned checking unit or value document processing apparatus and a value document. The checking unit or the value document processing apparatus is configured to check the value document, wherein the value document is configured as set out above. The checking unit and the value document, in particular its security element or the security element layer composite, are coordinated with one another in such a manner that an excitation radiation from the excitation device can excite (first) luminescent substances of the security element layer composite and the detection device is configured to detect emission radiation from the first luminescent substances. In particular, the wavelength ranges of the excitation radiation and/or emission radiation can be matched to the system of the value document and the checking unit or value document processing apparatus, since depending on the value document type other luminescent substances can be employed. Further, the positions of the excitation device and of the detection device on the checking unit can be matched to the types of value documents that are to be checked with the checking unit.

In one aspect of the invention, a method for checking a value document is made available, wherein the value document has a value document substrate and a security element and the security element has an optically variable effect for a viewer in incident light onto an upper side of the value document, at least in certain regions, and the value document (inside or outside this security element) has at least one luminescent substance, wherein the luminescent substance preferably has a primary emission radiation in the wavelength range between 700 nm and 2100 nm and preferably can be excited by an excitation radiation in the wavelength range between 400 nm and 2100 nm, in particular between 700 nm and 2100 nm; wherein the security element partially or completely covers the luminescent substance in incident light onto the upper side of the value document, wherein the value document is configured so that emission radiation from the luminescent substance to the upper side of the value document is hindered in the regions in which the security element in incident light onto the upper side of the value document covers the luminescent substance. The method comprises the following steps of:
applying to the value document an excitation radiation in incident light onto a lower side of the value document, wherein the excitation radiation comprises the wavelength range for excitation of the luminescent substance of the value document;
detecting an emission, in particular a rise and/or a decay behavior of the emission radiation, of the luminescent substance on the lower side of the value document over at least one areal region of the value document; and
ascertaining the authenticity of the value document from the detected emission, in particular from the rise and/or decay behavior.

This method makes possible a particularly high level of protection against forgery, since the luminescent substance is also checked in regions in which its emission does not exit at the upper side of the value document.

With the usual methods for checking value documents, regions with optical variable effects are masked out in targeted manner, since they are difficult to recognize and verify due to the optical variability. With the aid of the checking methods proposed here, it is now possible to check regions, in particular security elements with an optically variable effect, for existence and forgery. Further, for example, during a check of the lower side and the upper side of the value document, which can be carried out additionally, for example, the quality and fitness of the security element bringing about the optically variable effect can be analyzed and checked, since optionally the intensity value of the emission radiation of the luminescent substance, which is ascertained on the upper side of the value document, does not fulfill the standard values or limit ranges. In addition, for example, damaged value documents and/or forged value documents can be ascertained due to interferences in the intensity values and/or their areal distribution on the upper side and/or lower side. In addition, the presence of the security features, in particular the regions concerning the optically variable effect, is possible.

The value document substrate can be configured as set out above. As set out above, the security element can be an imprint, e.g. of an ink with optically variable pigments, a thread, a strip, a patch, one or several coatings and/or a security element of another type which can comprise an optically variable effect as already described.

In one embodiment, the method can be expanded to include the steps as already explained in relation to the preceding method according to the invention, for example the check on two sides of the value document and their evaluation.

In one embodiment, the method is executed by a checking unit or value document processing apparatus.

The invention will hereinafter be explained further by way of example with reference to the drawings. There are shown:

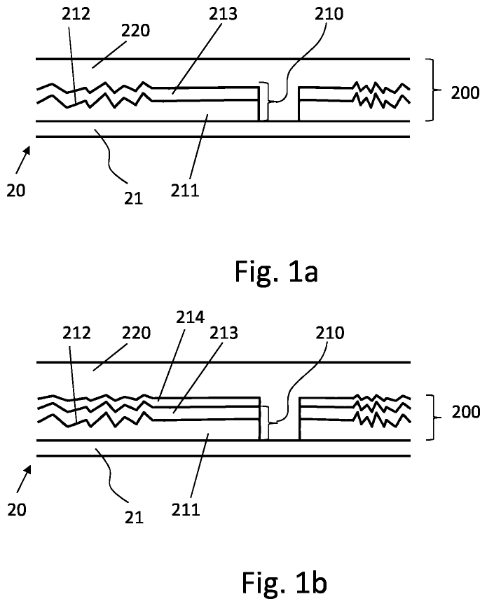

FIGS. 1 a, b schematic and exemplary representations of a security transfer element according to the invention;

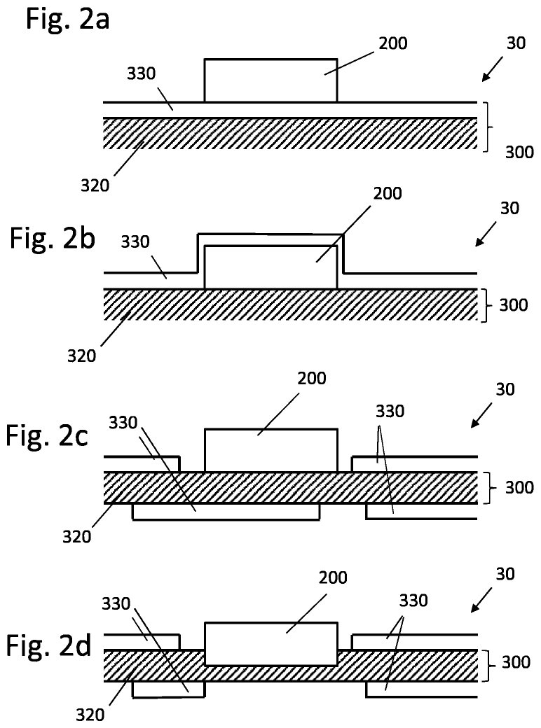

FIGS. 2 a-d a schematic view of a structure of a value document according to the invention; and

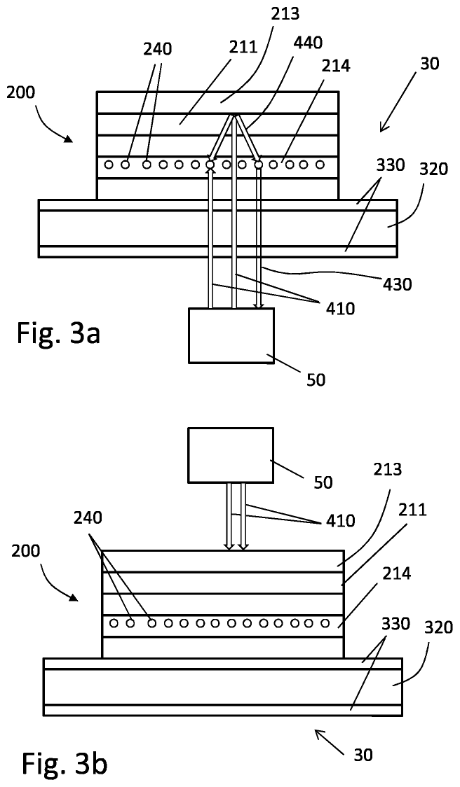

FIGS. 3 a, b a schematic representation of a checking method of a value document according to the invention.

In the embodiment examples, several (first) luminescent substances in the security element layer composite or, optionally, several (second) luminescent substances in the value document substrate are described. It goes without saying that also only one luminescent substance can be arranged in the security element layer composite or, optionally, in the value document substrate.

FIGS. 1a and 1b each show schematically an embodiment example of a security transfer element according to the invention. A security transfer element 20 in the form of a security strip is represented in FIG. 1a. The security transfer element 20 comprises a carrier film 21 of PET, for example. A security element layer composite 200 is detachably arranged on the carrier film 21. The security element layer composite 200 comprises a functional layer 210 and an adhesive layer 220. The functional layer 210 has an embossing lacquer 211 with an embossed structure 212, wherein the side of the embossing lacquer 211 which is not supplied with the embossed structure 212 faces the carrier film 21. The embossing lacquer 211 is coated on the side of the embossed structure 212 with a metallization 213, for example an aluminum layer. The metallization 213 matches to the shape of the embossing lacquer 211 and thus the embossed structure 212. The adhesive layer 220 is also arranged on the metalization 213. The adhesive layer 220 comprises several first luminescent substances.

In FIG. 1b a further security transfer element 20 according to the invention is represented and is constructed similarly to the security transfer element 20 from FIG. 1a. For the sake of simplicity and ease of understanding, the differences are substantially discussed. Identical and similar features are supplied with the same reference symbols for better understanding. The security transfer element 20 likewise has a carrier film 21 which is detachably connected to a security element layer composite 200. The security element layer composite 200 comprises an embossing lacquer 211 with an embossed structure 212, a metallization 213 which is arranged on the side of the embossing lacquer 211 which lies opposite the carrier film 21, and a luminescent substance layer 214 in which first luminescent substances are arranged. An adhesive layer 220 is arranged on the luminescent substance layer 214.

The security transfer element 20 of FIGS. 1a and 1b can be applied to a value document substrate (cf. FIGS. 2 a-d). For this purpose, the security transfer element 20 is placed on the value document substrate and connected to the value document substrate with the aid of activation of the adhesive layer 220. The carrier film 21 detachably connected to the security element layer composite 200 is removed subsequently. Merely the security element layer composite 200 remains on the value document substrate. The security element layer composite 200 is then arranged on the value document in such a manner that a viewer can perceive the embossed structure 212 in incident light onto the security element layer composite 200 (upper side) in such a manner that he can perceive an optically variable effect when changing the viewing angle. The metallization 213 serves as a reflector.

If the first luminescent substances of the luminescent substance layer 214 or the adhesive layer 220 are excited, their emission radiation is reflected by the metallization 213 in a direction which is not directed towards the upper side of the value document but towards the substrate. Emission radiation from the first luminescent substances can be detected only from the lower side of the value document.

The embossing lacquer 211, the metallization 213 and/or the luminescent substance layer 214 do not have to extend over the entire security transfer element 20. Rather, it is also conceivable that each of the layers is only applied in certain regions. In the examples of FIGS. 1a and 1b, the functional layer 200 has a recess.

FIGS. 2a to 2d represent exemplary and schematic embodiments of a value document 30 according to the invention.

In a first variant according to FIG. 2a, a value document 30 has a value document substrate 300. The value document substrate 300 comprises a value document substrate layer 320, which is printed with a printing layer 330, which in the present example is a printing ink layer 330. A security element layer composite 200 is arranged on the upper side of the value document substrate 300, namely on the printing ink layer 330. The security element layer composite 200 is thus separated from the value document substrate 300 by the printing ink layer 330. The side of the value document substrate 300 on which the security element layer composite 200 faces a viewer is the upper side of the value document 30.

The security element layer composite 200 is configured, for example, as represented in FIGS. 1a or 1b. The security element layer composite 200 comprises a functional layer and first luminescent substances. The functional layer is configured in such a manner that emission radiation of the first luminescent substances does not exit at the upper side of the value document 30. Rather, the emission radiation of excited first luminescent substances penetrates through the printing ink layer 330 and the value document substrate layer 320 and exits from the lower side of the value document 30.

To detect the luminescent substances of the security element layer composite 200, i.e. to detect the first luminescent substances, an excitation radiation must first traverse the value document substrate 300. The emission radiation of the excited first luminescent substances must then likewise traverse the value document substrate 300 in the opposite direction. As a result, the luminescence can, among other things, can be considerably weakened by scattering in the value document substrate 300 and absorption by the printing ink layer 330.

A value document 30 according to the invention is represented in FIG. 2b. The value document from FIG. 2b differs from the value document 30 from FIG. 2a in that the printing ink layer 330 is not merely applied to the value document substrate layer 320. In the embodiment example of FIG. 2b, the printing ink layer 330 is not part of the value document substrate 300. The security element layer composite 200 is arranged directly on the value document substrate 300. On the value document substrate 300 and the security element layer composite 200, the printing layer 330 is applied after the security element layer composite 200 has been arranged on the value document substrate 300 and thus also covers the security element layer composite 200, but not the connection area between the security element layer composite 200 and value document substrate 300. Instead of or in addition to the printing layer 330, an ink layer and/or lacquer layer and/or foil can be arranged.

The excitation radiation of the first luminescent substances in the security element layer composite 200 accordingly only has to penetrate through the value document substrate 300 in order to excite the first luminescent substances, and not the printing layer 330. Further, emission radiation from the first luminescent substances only needs to penetrate through the value document substrate 300 in order to be detected by a detector on the lower side of the value document 30, and not the printing layer 330.

The security element layer composite 200 can be executed as represented in FIGS. 1a and 1b. However, emission radiation from the first luminescent substances does not penetrate through the security element layer composite 200 in such a manner that the emission radiation exits from the upper side of the value document 30 and can be detected.

FIG. 2c shows a value document which is similar to the value document from FIG. 2b. In contrast, the printing layer 330 has a recess on the upper side of the value document substrate 300 in the region of the security element layer composite 200. A printing layer 330 is likewise arranged on the lower side of the value document substrate 300, which in transmitted light partially overlaps with the security element layer composite 200. Emission radiation and excitation radiation of the first luminescent substances must therefore penetrate through the printing layer 330 and the value document substrate layer 320 in certain regions. The printing layer 330 can accordingly weaken the excitation and emission of the first luminescent substances.

FIG. 2d shows a value document which is similar to that from FIG. 2c. In contrast, the value document substrate 300 has a thinning, so that after the security element layer composite 200 has been applied, the maximum thickness of the value document 30 does not increase too much. The thinning can substantially correspond to the thickness of the security element layer composite 200. Further, the region of the lower side of the value document which overlaps with the security element layer composite 200 in transmitted light was not printed in addition. Here, the excitation and emission radiation of the first luminescent substances only has to traverse the thin value document substrate 300 and not a printing layer 330, so that in this case the highest luminescence intensity can be achieved.

In the security element layer composite 200, viewed from the upper side of the value document 30, the first luminescent substance is located, preferably in one or several polymer layers below a reflective layer. Due to the strong absorption or reflection of the reflective layer, a reading out of the security element layer composite 200 from the upper side of the value document 30 is prevented on the one hand. On the other hand, an increase in the intensity of the first luminescent substances can be produced by the reflection of the excitation and emission radiation on its lower side, since e.g. scattered excitation radiation can thus impinge on the first luminescent substances several times.

FIGS. 3a and 3b show schematic representations of a checking method for a value document according to the invention. The checking of a value document 30 is represented here, which comprises a security element layer composite 200 which is arranged on a value document substrate 300. The security element layer composite 200 has an embossing lacquer layer 211 on which a reflective metallization 213 is applied. A luminescent substance layer 214 with first luminescent substances 240 is arranged below the embossing lacquer layer 211. The value document substrate 300 comprises a value document substrate layer 320, on which a printing layer 330 is applied on both sides.

The detection of the luminescence of the security element layer composite 200 or of the first luminescent substances 240 contained in the security element layer composite 200 is not carried out in the present case from the upper side of the value document 30, but from its lower side. An excitation radiation 410 from a sensor 50 passes through the printing layer 330, the value document substrate layer 320, again a further printing layer 330, part of the security element layer composite 200 and reaches the luminescent substance layer 214, which contains the first luminescent substances 240, stimulating these. Further, the excitation radiation 410 passes another part of the security element layer composite 200, reaches the metallization 213 and is reflected back (or scattered) there, so that the excitation radiation 410 cannot penetrate through the security element layer composite 200 and exit at the upper side.

Through multiple scattering and reflection, it is thus possible for the excitation radiation 410 to pass the part of the security element layer composite 200 containing the first luminescent substances 240 multiple times, whereby the metallization 213, if configured correspondingly, makes an important contribution to increasing the luminescence intensity of the security element layer composite 200. This contribution of the excitation radiation 410 at the value document substrate layer 320, for example, obtained through multiple scattering and/or reflection, is symbolized here schematically by the arrows 440.

The emission radiation 430 of the first luminescent substances 240 is generally emitted in undirected manner in all spatial directions. The luminescent substances 240 excited to luminescence therefore send back part of the emission radiation 430 directly (it thus passes the same path as the excitation radiation 410). However, a considerably larger part only reaches the sensor 50 only after several scattering or reflection processes. For example, a further part of the emission radiation 430 reaches the metallization 214 and is reflected (or scattered) on it and can thus likewise contribute to the detected emission radiation 430, which exits on the side of the value document 30 that does not carry the security element layer composite 200, here at the lower printing layer 330. The emission radiation 430 reaches sensor 50, which detects it.

The intensity of the emission radiation 430 detected at the sensor 50 is therefore most highly dependent on various factors:
the structure of the security element layer composite 200 (e.g. distance between first luminescent substances 240 and the metallization 214),
the scattering behavior of the individual layers,
the structure of the metallization 214 (alignment and mattedness of the reflective metal areas, the scattering behavior of the value document substrate layer 320, etc.).

FIG. 3b shows the same value document 30 as in FIG. 3a, but here the measurement is carried out from the other side of value document 30. The excitation radiation 410 cannot penetrate through the metallization 214, so the luminescent substances 240 are not excited and do not emit any emission radiation.

In the application case, it is possible that a small portion of the excitation radiation 410 traverses the metallization 214, e.g. because said metallization is not completely reflective, and the luminescent substances 240 are thus partially excited. However, the resulting emission radiation would have to penetrate through the metallization 214 again, so that it is greatly weakened once more. The emission radiation detectable by the sensor 50 would therefore be very low.

1.-32. (canceled)

33. A security transfer element for a value document, comprising a security element layer composite and a carrier film detachably connected to the security element layer composite, wherein the security element layer composite
has a functional layer which, after being transferred to a value document, develops an optically variable effect for a viewer;
has an adhesive layer;
has an upper side which, after the security element layer composite has been transferred to a value document substrate, faces the viewer, wherein the adhesive layer is arranged on the side of the functional layer which lies opposite the upper side; and
has at least one luminescent substance, wherein the luminescent substance is arranged in the adhesive layer and/or in a luminescent substance layer, wherein the adhesive layer and/or the luminescent substance layer is arranged on the side of the functional layer in the security element layer composite which is opposite the upper side;
wherein the luminescent substance has a primary emission radiation in the wavelength range between 700 nm and 2100 nm and can be excited by an excitation radiation in the wavelength range between 400 nm and 2100 nm; and the functional layer is configured to be opaque to the emission radiation of the luminescent substance.

34. The security transfer element according to claim 32, wherein the emission radiation of the luminescent substance of the security element layer composite lies in a wavelength range between 900 nm and 1300 nm, and/or 1300 nm and 1600 nm, and/or 1600 nm and 1850 nm and/or 1850 and 2100 nm.

35. The security transfer element according to claim 33, wherein the luminescent substance of the security element layer composite does not have any additional anti-Stokes emission that can be visually recognized by humans.

36. The security transfer element according to claim 33, wherein the luminescent substance of the security element layer composite comprises organic dyes, organometallic complexes with in erbium, thulium, holmium, neodymium or ytterbium, and/or doped inorganic pigments with the dopants erbium, thulium, holmium, neodymium or ytterbium or doped with transition metals including chromium, manganese and/or iron.

37. The security transfer element according to claim 33, wherein the at least one luminescent substance has a grain size (D99) of less than 15 μm.

38. The security transfer element according to claim 33, wherein the functional layer is configured to be absorbent and/or reflective.

39. The security transfer element according to claim 33, wherein the functional layer comprises a metallic layer and/or a metallic coating at least in certain regions,
wherein the metallic layer and/or the metallic coating is configured on the side of the functional layer which faces away from the viewer or is configured on the side of the functional layer which faces the viewer.

40. The security transfer element according to claim 33, wherein the functional layer developing the optically variable effect comprises a reflective embossed structure, in a diffractive structure and/or a reflective microstructure, and/or has transparent highly refractive layers, thin-film elements with a color shift effect, with a reflective layer and a semitransparent layer and a dielectric layer arranged in between, layers of liquid crystalline material, of cholesteric liquid crystalline material, printing layers based on effect pigment compositions with viewing angle-dependent effect or with different colors and/or a multilayer structure, namely two semitransparent layers and a dielectric layer arranged between the two semitransparent layers.

41. The security transfer element according to claim 33, wherein the security element layer composite has a scattering layer with light-scattering properties,
wherein the scattering layer is arranged adjacent to the luminescent substance and/or is arranged adjacent to the luminescent substance layer; and/or
is part of the functional layer.

42. A value document comprising an areal value document substrate and a security element layer composite, wherein
the security element layer composite
has a functional layer which, when viewed in incident light onto an upper side of the functional layer, develops an optically variable effect for a viewer;
has an adhesive layer;
has an upper side which, after the security element layer composite has been transferred to a value document substrate, faces the viewer, wherein the adhesive layer is arranged on the side of the functional layer which lies opposite the upper side; and
has at least one first luminescent substance, wherein the first luminescent substance is arranged in the adhesive layer and/or in a luminescent substance layer which is arranged on the side of the functional layer opposite the upper side in the security element layer composite; and
the security element layer composite is arranged on an upper side of the value document substrate in such a manner that the functional layer developing the optically variable effect is aligned such that the optically variable effect can be recognized in incident light onto an upper side of the value document and the security element layer composite in incident light onto a lower side of the value document which lies opposite the upper side of the value document is covered at least in certain regions by the value document substrate;
wherein the at least one first luminescent substance has a primary emission radiation in the wavelength range between 700 nm and 2100 nm and can be excited by an excitation radiation in the wavelength range between 400 nm and 2100 nm; and
the functional layer is configured to be opaque to the emission radiation of the luminescent substance.

43. The value document according to claim 42, wherein the intensity of the emission radiation of the at least one first luminescent substance of the security element layer composite is significantly higher on the lower side than on the upper side of the value document,
wherein no emission radiation of the first luminescent substance exits on the upper side.

44. The value document according to claim 42, wherein the value document substrate has at least one second luminescent substance.

45. The value document according to claim 42, wherein the emission radiation of the first luminescent substance of the security element layer composite lies in a wavelength range between 900 nm and 1300 nm and/or 1300 nm and 1600 nm, and/or 1600 nm and 1850 nm and/or 1850 and 2100 nm.

46. The value document according to claim 42, wherein the first luminescent substance of the security element layer composite has no additional anti-Stokes emission that can be visually recognized by humans.

47. The value document according to claim 42, wherein the first luminescent substance of the security element layer composite and/or the second luminescent substance of the value document substrate comprises organic dyes, organometallic complexes with erbium, thulium, holmium, neodymium or ytterbium, and/or doped inorganic pigments with the dopants erbium, thulium, holmium, neodymium or ytterbium or doped with transition metals, including chromium, manganese and/or iron.

48. The value document according to claim 42, wherein the at least one first luminescent substance of the security element layer composite and/or the at least one second luminescent substance of the value document substrate has a grain size (D99) of less than 15 μm.

49. The value document according to claim 42, wherein the functional layer is configured to be absorbent and/or reflective, in relation to the emission radiation of the first luminescent substance.

50. The value document according to claim 42, wherein the functional layer comprises at least in certain regions, a metallic layer and/or a metallic coating,
wherein the metallic layer and/or the metallic coating is configured to be on the side of the functional layer which faces away from the viewer.

51. The value document according to claim 42, wherein the functional layer developing the optically variable effect comprises a reflective embossed structure, in a diffractive structure and/or a reflective microstructure, and/or
has transparent highly refractive layers, thin-film elements with a color shift effect, with a reflective layer and a semitransparent layer and a dielectric layer arranged in between, layers of liquid crystalline material, of cholesteric liquid crystalline material, printing layers based on effect pigment compositions with viewing angle-dependent effect or with different colors and/or a multilayer structure, namely two semitransparent layers and a dielectric layer arranged between the two semitransparent layers.

52. The value document according to claim 42, wherein the security element layer composite has a scattering layer with light-scattering properties,
wherein the scattering layer is arranged adjacent to the first luminescent substance and/or is arranged adjacent to the luminescent substance layer; and/or
is part of the functional layer.

53. The value document according to claim 42, wherein the intensity of the emission radiation of the at least one first luminescent substance in incident light onto the lower side of the value document is more than 50% higher than in incident light onto the upper side of the value document.

54. The value document according to claim 42, wherein the value document substrate comprises at least one layer of a paper substrate layer,
wherein the paper substrate layer comprises cellulose fibers and/or fillers,
wherein the fillers are titanium dioxide, organic aids, carboxymethyl cellulose, and/or
comprises at least one plastic layer, and/or
the value document substrate has a Kubelka-Munk scatter coefficient with a value between 10 and 80 l/mm in a wavelength range from 400 nm to 2100 nm.

55. The value document according to claim 42, wherein the value document substrate comprises at least one second luminescent substance,
wherein the emission wavelength range of the emission radiation and/or excitation wavelength range of the second luminescent substance corresponds substantially the wavelength range of the emission radiation and/or excitation of the first luminescent substance of the security element layer composite,
wherein the first luminescent substance of the security element layer composite and the second luminescent substance of the value document substrate have a mutually complementary luminescence behavior.

56. The value document according to claim 42, wherein the first luminescent substance has a refractive index which is matched to the refractive index of the material surrounding the first luminescent substance,
wherein the refractive index of the first luminescent substance is equal to the refractive index of the material surrounding the first luminescent substance.

57. A method for checking a value document according to claim 42, having the following steps of:
applying to the value document an excitation radiation in incident light onto the lower side of the value document, wherein the excitation radiation comprises the wavelength range for excitation of the first luminescent substance of the security element layer composite;
detecting an emission, in a rise and/or a decay behavior of the emission radiation, of the first luminescent substance of the security element layer composite on the lower side of the value document over at least one areal region of the value document; and
ascertaining the authenticity of the security element layer composite from the detected emission, from the rise and/or decay behavior of the detected emission radiation.

58. The method according to claim 57, wherein the areal region of the value document comprises the region of the security element layer composite and a region surrounding the security element layer composite which has an area of at least 100% of the area of the security element layer composite.

59. The method according to claim 57, wherein the detected emission, in the detected rise behavior and/or the detected decay behavior, results in a two-dimensional pattern over the areal region, and the pattern corresponds to the type of security element layer composite.

60. The method according to claim 57, wherein the further steps of:
applying to the value document an excitation radiation in incident light onto the upper side of the value document, wherein the excitation radiation comprises the wavelength range for excitation of the first luminescent substance of the security element layer composite;
detecting an emission, in a rise and/or a decay behavior of the emission radiation, of the first luminescent substance of the security element layer composite on the upper side of the value document over at least one areal region of the value document; and
comparing the emission detected on the upper side of the value document with the emission detected on the lower side of the value document for checking the authenticity of the value document.

61. A checking unit for checking value documents, with
an excitation device for applying to the respective value document an excitation radiation in incident light onto the lower side of the value document, wherein the excitation radiation comprises the wavelength range for excitation of the first luminescent substance of the security element layer composite of the value document;
a detection device for detecting an emission, in a rise and/or a decay behavior of the emission radiation, of the first luminescent substance of the security element layer composite on the lower side of the respective value document over at least one areal region of the respective value document; and
an evaluation device for checking the authenticity of the respective value document based on the detected emission, based on the rise and/or decay behavior of the detected emission radiation,
wherein the checking unit is configured to carry out the method according to claim 57.

62. A value document processing apparatus for checking value documents, comprising an interface for feeding value documents, at least one checking unit according to claim 61 for checking the value documents and an output unit for outputting the value documents.

63. A system comprising:
a checking unit and/or a value document processing apparatus according to claim 62; and
a security transfer element comprising a security element layer composite and a carrier film detachably connected to the security element layer composite, wherein the security element layer composite
has a functional layer which, after being transferred to a value document, develops an optically variable effect for a viewer;
has an adhesive layer;
has an upper side which, after the security element layer composite has been transferred to a value document substrate, faces the viewer, wherein the adhesive layer is arranged on the side of the functional layer which lies opposite the upper side; and
has at least one luminescent substance, wherein the luminescent substance is arranged in the adhesive layer and/or in a luminescent substance layer, wherein the adhesive layer and/or the luminescent substance layer is arranged on the side of the functional layer in the security element layer composite which is opposite the upper side;
wherein the luminescent substance has a primary emission radiation in the wavelength range between 700 nm and 2100 nm and can be excited by an excitation radiation in the wavelength range between 400 nm and 2100 nm; and the functional layer is configured to be opaque to the emission radiation of the luminescent substance; and/or
a value document comprising:
an areal value document substrate and a security element layer composite, wherein the security element layer composite
has a functional layer which, when viewed in incident light onto an upper side of the functional layer, develops an optically variable effect for a viewer;
has an adhesive layer;
has an upper side which, after the security element layer composite has been transferred to a value document substrate, faces the viewer, wherein the adhesive layer is arranged on the side of the functional layer which lies opposite the upper side; and
has at least one first luminescent substance, wherein the first luminescent substance is arranged in the adhesive layer and/or in a luminescent substance layer which is arranged on the side of the functional layer opposite the upper side in the security element layer composite;
wherein the security element layer composite is arranged on an upper side of the value document substrate in such a manner that the functional layer developing the optically variable effect is aligned such that the optically variable effect can be recognized in incident light onto an upper side of the value document and the security element layer composite in incident light onto a lower side of the value document which lies opposite the upper side of the value document is covered at least in certain regions by the value document substrate;
wherein the at least one first luminescent substance has a primary emission radiation in the wavelength range between 700 nm and 2100 nm and can be excited by an excitation radiation in the wavelength range between 400 nm and 2100 nm; and
the functional layer is configured to be opaque to the emission radiation of the luminescent substance.

64. A method for checking a value document, wherein the value document has a value document substrate and a security element, and the security element has an optically variable effect for a viewer in incident light onto an upper side of the value document at least in certain regions, and the value document has at least one luminescent sub stance,
wherein the luminescent substance has a primary emission radiation in the wavelength range between 700 nm and 2100 nm and is arranged to be excited by an excitation radiation in the wavelength range between 400 nm and 2100 nm;
wherein the security element partially or completely covers the luminescent substance in incident light onto the upper side of the value document,
wherein the value document is configured so that emission radiation from the luminescent substance to the upper side of the value document in the regions in which the security element in incident light onto the upper side the value document covers the luminescent substance is hindered;
with the steps of:
applying to the value document an excitation radiation in incident light onto a lower side of the value document, wherein the excitation radiation comprises the wavelength range for excitation of the luminescent substance of the value document;
detecting an emission, in a rise and/or a decay behavior of the emission radiation, of the luminescent substance on the lower side of the value document over at least one areal region of the value document; and
ascertaining the authenticity of the value document from the detected emission, from the rise and/or decay behavior.
